(19) United States
(12) Patent Application Publication
(10) Pub. No.: US 2012/0256957 A1
(43) Pub. Date: Oct. 11, 2012

(54) IMAGE PROCESSING METHOD OF PERFORMING SCALING OPERATIONS UPON RESPECTIVE DATA PORTIONS FOR MULTI-CHANNEL TRANSMISSION AND IMAGE PROCESSING APPARATUS THEREOF

(76) Inventors: Sau-Kwo Chiu, Hsinchu City (TW); Te-Hao Chang, Taipei City (TW); Chia-Lei Yu, Taipei City (TW)

(21) Appl. No.: 13/083,592

(22) Filed: Apr. 10, 2011

(51) Int. Cl. G06T 3/40; G09G 5/00

(52) U.S. Cl. 345/634; 345/667

(57) ABSTRACT

An image processing method includes: deriving a plurality of first data portions from an original data of a first input image, wherein the first data portions correspond to a plurality of partial image areas within the first input image respectively; performing a plurality of scaling operations upon the first data portions respectively, and accordingly generating a plurality of first processed data portions; and outputting a plurality of display data portions through a plurality of channels respectively, wherein the display data portions are derived from at least the first processed data portions respectively.

### BACKGROUND

The disclosed embodiments of the present invention relate to image processing, and more particularly, to an image processing method of performing scaling operations upon respective data portions derived from an original data of an input image for multi-channel transmission and related image processing apparatus thereof.

General speaking, a display panel (e.g., a liquid crystal display panel) is driven by a display driving signal to control the pixels of the display panel. For example, regarding a conventional television/monitor application, a controller chip is utilized to generate the display driving signal and transmit the display driving signal to the display panel via a single channel. However, there is a demand for a higher resolution and a higher frame rate in a novel television/monitor application. For example, a resolution complying with a full high-definition (HD) standard and a frame rate of 120/240 Hz may be required. Therefore, to transmit the pixel data of the pixels via the single channel under a high resolution setting and a high frame rate setting of the pixel panel, the output pixel clock rate must be very high. Consider an exemplary case where a display panel has a 2560×1080 resolution with 2900×1125 horizontal/vertical (H/V) timing and operates at a frame rate of 240 Hz. The pixel clock rate would be 2900×1125×240 pixels per second (i.e., 783M pixels/sec). It is possible that the required pixel clock rate is higher than the highest pixel clock rate supported by the conventional controller chip, which may cause a system stability issue.

Moreover, after receiving an original data of an input image, the controller chip may apply specific image processing upon the original data of the input image and generate the display driving signal according to the processing result. For example, it is possible that the resolution of the input image is different from the resolution of the display panel. Therefore, a scaling operation should be performed to convert the original data of the input image into a processed data of a scaled image complying with the resolution of the display panel. Similarly, in a case where the display panel has a high resolution and operates at a high frame rate, the output pixel clock rate of the processed data transmitted via the single channel would be very high.

Thus, there is a need for an innovative design which can reduce the pixel clock rate when a pixel data output is required to be transmitted to the display panel having a high resolution and operating at a high frame rate.

### SUMMARY

In accordance with exemplary embodiments of the present invention, an image processing method of performing scaling operations upon respective data portions derived from an original data of an input image for multi-channel transmission and related image processing apparatus thereof are proposed to solve the above-mentioned problem.

According to a first aspect of the present invention, an exemplary image processing method is disclosed. The exemplary image processing method includes the following steps: deriving a plurality of first data portions from an original data of a first input image, wherein the first data portions correspond to a plurality of partial image areas within the first input image respectively; performing a plurality of scaling operations upon the first data portions respectively, and accordingly generating a plurality of first processed data portions; and outputting a plurality of display data portions through a plurality of channels respectively, wherein the display data portions are derived from at least the first processed data portions respectively.

According to a second aspect of the present invention, an exemplary image processing apparatus is disclosed. The exemplary image processing apparatus includes a first splitting module, a plurality of first scaling circuits, and a plurality of output circuits. The first splitting module is arranged for deriving a plurality of first data portions from an original data of a first input image, wherein the first data portions correspond to a plurality of partial image areas within the first input image respectively. The first scaling circuits are coupled to the first splitting module, and arranged for performing a plurality of scaling operations upon the first data portions respectively, and accordingly generating a plurality of first processed data portions. The output circuits are coupled to the first scaling circuits respectively, and arranged for outputting a plurality of display data portions through a plurality of channels respectively, wherein the display data portions are derived from at least the first processed data portions respectively.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating an image processing apparatus according to a first exemplary embodiment of the present invention.

FIG. 2 is a diagram illustrating partial image areas to which the data portions correspond.

FIG. 3 is a diagram illustrating an exemplary implementation of the scaling operation with multi-tap filtering.

FIG. 4 is a timing diagram of the output of the display data portions that are transmitted from respective output circuits to the display panel.

FIG. 5 is a diagram illustrating the merging of the display data portions received at the display panel.

FIG. 6 is a block diagram illustrating an image processing apparatus according to a second exemplary embodiment of the present invention.

FIG. 7 is a diagram illustrating a generalized arrangement of the partial image areas according to an embodiment of the present invention.

FIG. 8 is a diagram illustrating another generalized arrangement of the partial image areas according to an embodiment of the present invention.

FIG. 9 is a block diagram illustrating an exemplary single-chip implementation according to the present invention.

FIG. 10 is a block diagram illustrating an exemplary multi-chip implementation according to the present invention.

FIG. 11 is a flowchart illustrating an image processing method according to an exemplary embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

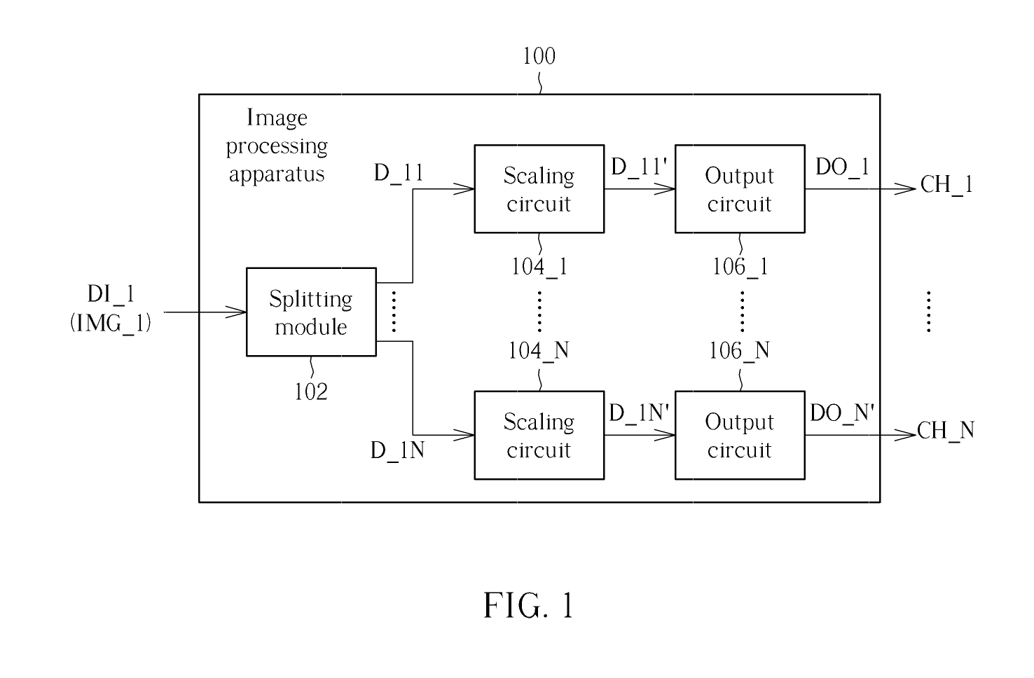

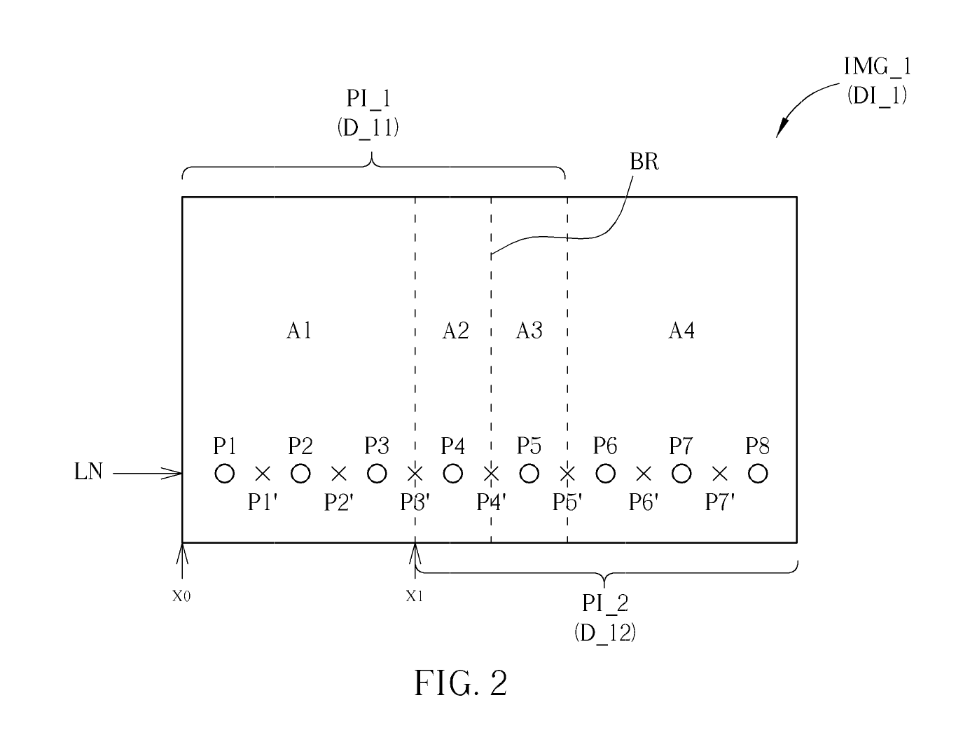

Please refer to FIG. 1, which is a block diagram illustrating an image processing apparatus according to a first exemplary embodiment of the present invention. The exemplary image processing apparatus 100 includes, but is not limited to, a splitting module 102, a plurality of scaling circuits 104_1-104_N, and a plurality of output circuits 106_1-106_N. The splitting module 102 is arranged for deriving a plurality of data portions D_11-D_1N from an original data DI_1 of an input image IMG_1, wherein the data portions D_11-D_1N correspond to a plurality of partial image areas within the input image IMG_1 respectively. By way of example, but not limitation, the input image IMG_1 may be a still picture, a frame of a video stream, or an on-screen display (OSD) image. Please refer to FIG. 2, which is a diagram illustrating partial image areas to which the data portions correspond. For simplicity and clarity, the number of the data portions D_11-D_1N is assumed to be 2. Therefore, in this exemplary embodiment, the splitting module 102 generates two data portions D_11 and D_12 according to the original data DI_1 of the input image IMG_1. As shown in FIG. 2, the partial image areas PI_1 and PI_2 to which the data portions D_11 and D_12 correspond are overlapped with each other. More specifically, the partial image area PI_1 is consisted of areas A1, A2, and A3, and the partial image area PI_2 is consisted of areas A2, A3, and A4. As can be seen from FIG. 2, the size of the area A1 is equal to the size of the area A4, and the size of the area A2 is equal to the size of the area A3. Therefore, the total size of the areas A1 and A2 is equal to the total size of the areas A3 and A4. However, this is for illustrative purposes only, and is not meant to be a limitation of the present invention.

Please refer to FIG. 1 again. In accordance with the example shown in FIG. 2, every two adjacent partial image areas of the partial image areas within the input image IMG_1 may be overlapped with each other. The data portions D_11-D_1N corresponding to the partial image areas are transmitted to the scaling circuits 104_1-104_N respectively. As shown in FIG. 1, the scaling circuits 104_1-104_N are coupled to the splitting module 102, and arranged for performing a plurality of scaling operations upon the data portions D_11-D_1N respectively, and accordingly generating a plurality of processed data portions D_11′-D_1N′.

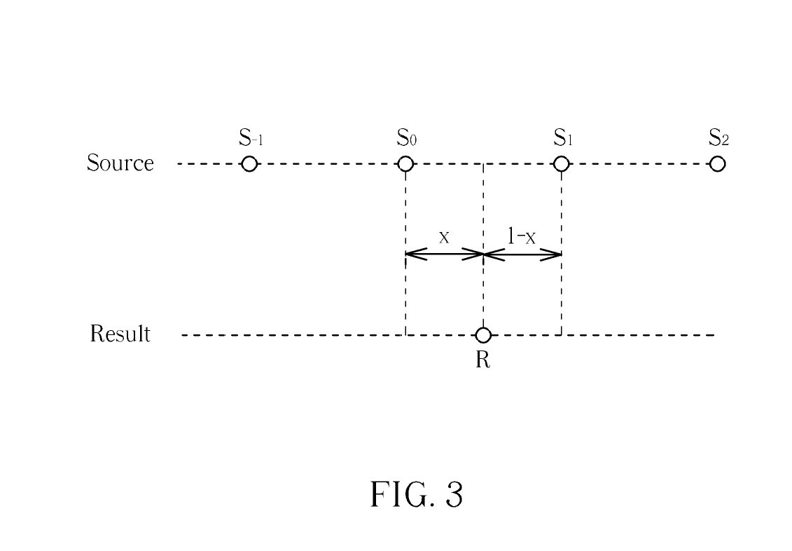

By way of example, but not limitation, each of the scaling operations performed by the scaling circuits 104_1-104_N is a scaling operation (e.g., an up-scaling operation or a down-scaling operation) with multi-tap filtering. Please refer to FIG. 3, which is a diagram illustrating an exemplary implementation of the scaling operation with multi-tap filtering. In this example, pixel values of four successive pixels S₋₁, S₀, S₁, and S₂ included in the input of the scaling circuit are utilized for determining a pixel value of the pixel R included in the output of the scaling circuit. The pixel value of the pixel R may be determined by the following formula:

R=C₋₁S₋₁+C₀S₀+C₁S₁+C₂S₂ (1)

In above formula, C₋₁, C₀, C₁, and C₂ are tap coefficients, where C₋₁=−x³+2x²−x, C₀=x³−2x²+1, C₁=−x^{3+x}²+x, C₂=x³−x², and x represents an initial phase.

To achieve a seamless output presented on the display panel, the scaling circuits 104_1-104_N set a plurality of predetermined initial phases corresponding to a plurality of channels CH_1-CH_N respectively, and perform the scaling operations with multi-tap filtering upon the data portions D_{—}11-D_1N according to the predetermined initial phases respectively. Regarding the example shown in FIG. 2, one predetermined initial phase x₀ (e.g., x₀=0) is set for processing the data portion D_11, and another predetermined initial phase x₁ is set for processing the data portion D_12. Please note that, due to the fact that the partial image area PI_1 has areas A2 and A3 included therein, a pixel value of a pixel (e.g., the pixel R shown in FIG. 3 or the pixel P4′ shown in FIG. 2) at a boundary BR between areas A2 and A3 may be calculated by one scaling circuit which receives the data portion D_11; additionally, due to the fact that the partial image area PI_2 also has areas A2 and A3 included therein, a pixel value of the same pixel (e.g., the pixel R shown in FIG. 3 or the pixel P4′ shown in FIG. 2) at the boundary BR between areas A2 and A3 would be calculated by another scaling circuit which receives the data portion D_12. With a proper setting of the predetermined initial phases x₀ and x₁, pixel values of the same pixel that are respectively calculated by different scaling circuits would be identical to each other, resulting in a seamless output presented on the display panel. Further description is detailed as follows.

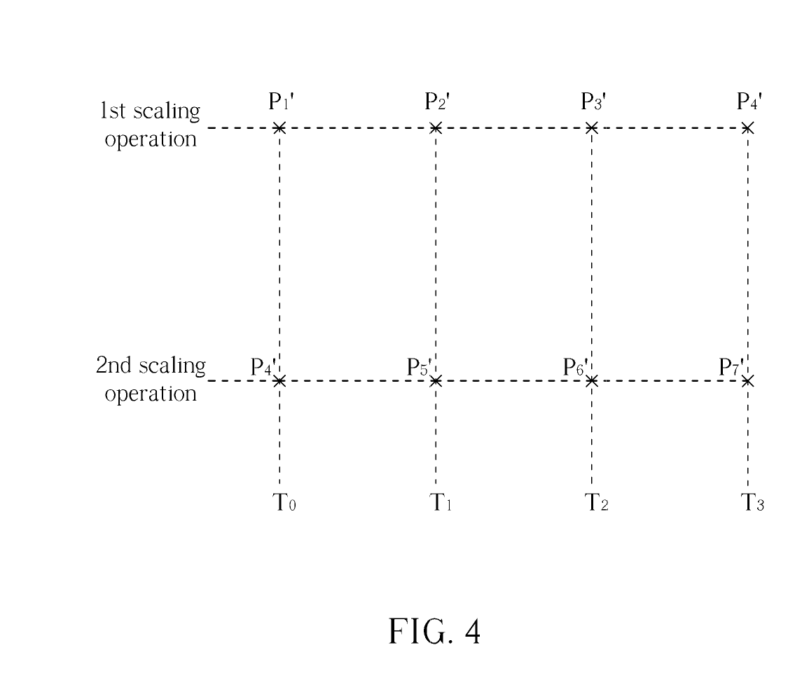

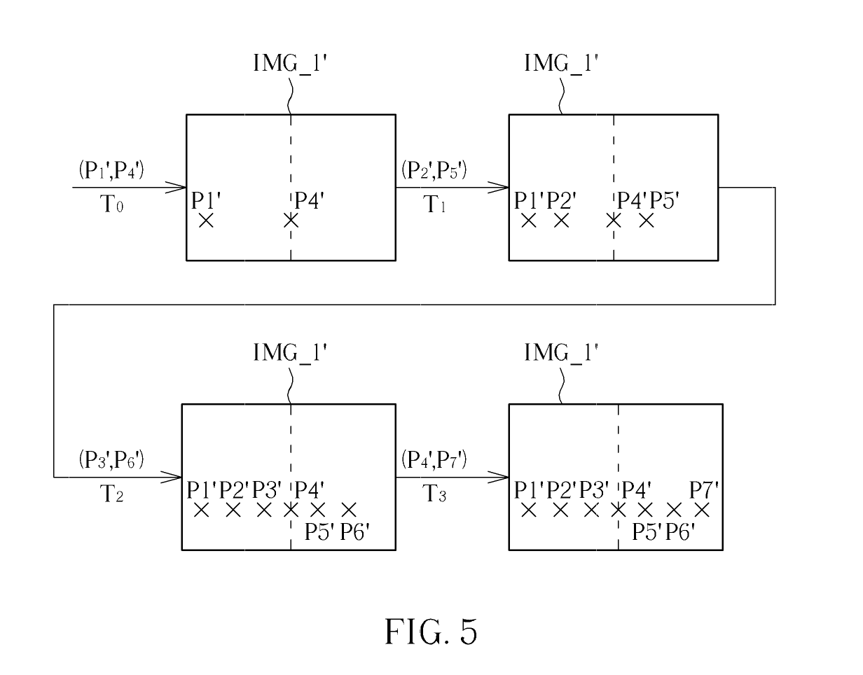

Please refer to FIG. 1 again. The output circuits 106_1-106_N are coupled to the scaling circuits 104_1-104_N respectively, and arranged for outputting a plurality of display data portions DO_1-DO_N through different channels CH_1-CH_N respectively. The display data portions D_1-DO_N are derived from the processed data portions D_11′-D_1N′ respectively. In this exemplary embodiment, the processed data portions D_11′-D_1N′ may directly act as the display data portions DO_1-DO_N respectively. Regarding a receiving end such as a display panel (not shown), the display panel receives the display data portions DO_1-DO_N (i.e., the processed data portions D_11′-D_1N′ in this exemplary embodiment), and obtains pixel data of a scaled image to be directly displayed on the display panel according to the received display data portions DO_1-DO_N (i.e., the processed data portions D_11′-D_1N′). Please refer to FIG. 4 in conjunction with FIG. 2 and FIG. 5. FIG. 4 is a timing diagram of the output of the display data portions that are transmitted from respective output circuits to the display device, and FIG. 5 is a diagram illustrating the merging of the display data portions received at the display panel. For simplicity and clarity, the number of the data portions D_11-D_1N is assumed to be 2, as shown in FIG. 2. Besides, suppose that there are eight pixels P1-P8 located at one row LN, where pixels P1-P5 belong to the partial image area PI_1 of the input image IMG_1, and pixels P4-P8 belong to the partial image area PI_2 of the input image IMG_1. That is, pixel values of the pixels P1-P5 are part of the data portion D_11, and pixel values of pixels P4-P8 are part of the data portion D_12. Regarding a first scaling operation with multi-tap filtering that is applied to the pixels P1-P5, it is assumed that pixels values of pixels P1′-P4′ will be generated one by one. Similarly, regarding a second scaling operation with multi-tap filtering that is applied to the pixels P4-P8, it is also assumed that pixels values of pixels P4′-P7′ will be generated one by one. The scaling circuits which perform the aforementioned first and second scaling operations with multi-tap filtering are arranged to operate according to a parallel processing fashion. Therefore, as can be seen from FIG. 4, pixel values of the pixels P1′ and P4′ will be generated at a time point T₀, pixel values of the pixels P2′ and P5′ will be generated at a time point T₁, pixel values of the pixels P3′ and P6′ will be generated at a time point T₂, and pixel values of the pixels P4′ and P7′ will be generated at a time point T₃. In this example, a pixel value of the pixel P4′ is generated at one time point T₀, and a pixel value of the pixel P4′ is generated at another time point T₃.

As mentioned above, when the predetermined initial phases x₀ and x₁ are properly set, the pixel value of the pixel P4′ generated at one time point T₀ would be identical to the pixel value of the pixel P4′ generated at another time point T₃. As shown in FIG. 5, the display panel (not shown) displays a scaled image IMG_1′ according to the pixel data simultaneously received from multiple channels between the display panel and the image processing apparatus 100 at different time points. Therefore, pixel values of the pixels P1′ and P4′ included in the scaled image IMG_1′ are obtained by the display panel at the time point T₀; pixel values of the pixels P2′ and P5′ included in the scaled image IMG_1′ are obtained by the display panel at the time point T₁; pixel values of the pixels P3′ and P6′ included in the scaled image IMG_1′ are obtained by the display panel at the time point T₂; and pixel values of the pixels P4′ and P7′ included in the scaled image IMG_1′ are obtained by the display panel at the time point T₃. As the pixel value of the pixel P4′ obtained by the display panel at the time point T₃ is identical to the pixel value of the pixel P4′ obtained by the display panel at the time point T₀ which is prior to the time point T₃, a seamless output is therefore generated. Though the pixel value of the pixel P4′ is generated at the time point T₃ due to a parallel processing scheme employed by the scaling circuits, the pixel value of the pixel P4′ obtained by the display panel at the time point T₃ is redundant and may be discarded. Please note that the merging example mentioned above is for illustrative purposes only, and is not meant to be a limitation of the present invention.

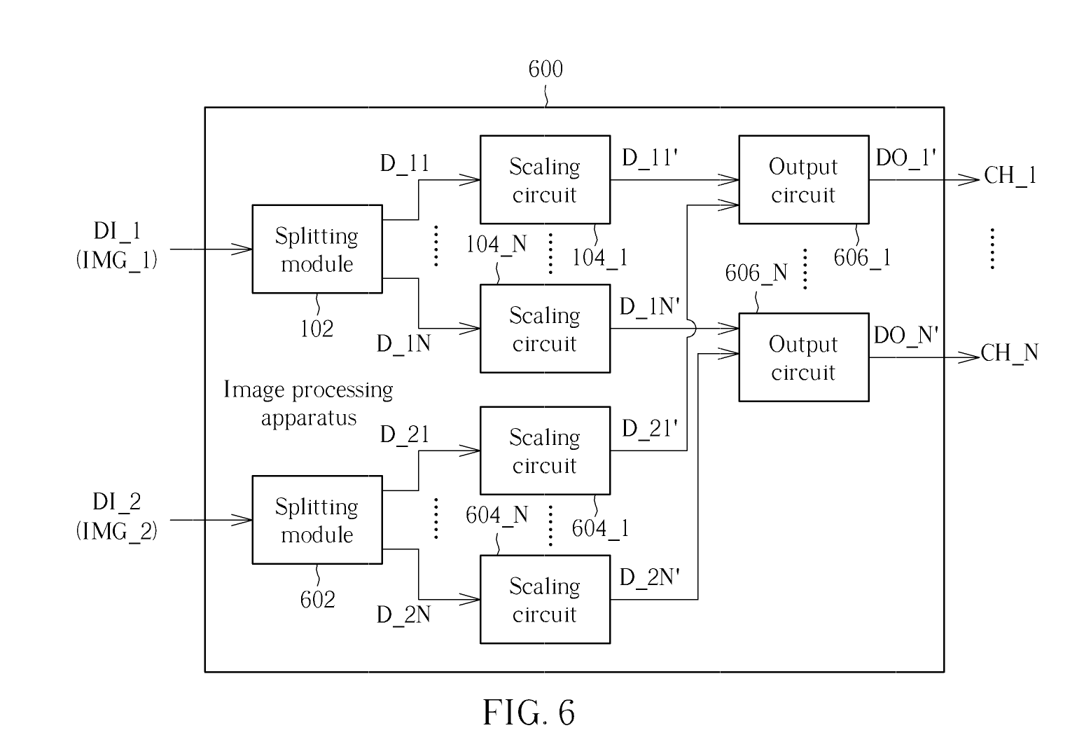

In the exemplary embodiment shown in FIG. 1, the image processing apparatus 100 is arranged to generate display data portions DO₁-DO_N to channels CH_1-CH_N by processing a single input (e.g., the original data DI_1 of the input image IMG_1). However, other alternative designs are feasible. Please refer to FIG. 6, which is a block diagram illustrating an image processing apparatus according to a second exemplary embodiment of the present invention. The exemplary image processing apparatus 600 includes, but is not limited to, the aforementioned splitting module 102 and scaling circuits 104_1-104_N, a splitting module 602, a plurality of scaling circuits 604_1-604_N, and a plurality of output circuits 606_1-606_N. The splitting module 602 is arranged for deriving a plurality of data portions D_21-D_2N from an original data DI_2 of an input image IMG_2, wherein the data portions D_21-D_2N correspond to a plurality of partial image areas within the input image IMG_2 respectively. For example, the partial image areas may be determined according to the rule employed for determining the partial image areas PI_1 and PI_2 shown in FIG. 2. That is, every two adjacent partial image areas of the partial image areas within the input image IMG_2 may be overlapped with each other. The scaling circuits 604_1-604_N are coupled to the splitting module 602, and arranged for performing a plurality of scaling operations upon the data portions D_21-D_2N respectively, and accordingly generating a plurality of processed data portions D_21′-D_2N′. For example, each of the scaling operations performed by the scaling circuits 604_1-604_N is a scaling operation (e.g., an up-scaling operation or a down-scaling operation) with multi-tap filtering. Specifically, the function and operation of the splitting module 602 are similar/identical to that of the splitting module 102, and the function and operation of the scaling circuits 604_1-604_N are similar/identical to that of the scaling circuits 104_1-104_N. As a person skilled in the art can readily understand details of the splitting module 602 and scaling circuits 604_1-604_N shown in FIG. 6 after reading above paragraphs directed to the splitting module 102 and scaling circuits 104_1-104_N shown in FIG. 1, further description is omitted here for brevity.

Regarding the output circuits 606_1-606_N, they are coupled to the scaling circuits 104_1-104_N respectively and further coupled to the scaling circuits 604_1-604_N respectively. In this exemplary embodiment, each of the output circuits 606_1-606_N is equipped with the mixing capability. Therefore, the output circuits 606_1-606_N are arranged for generating the display data portions DO_V-DO_N′ by respectively mixing the processed data portions D_11′-D_1N′ generated from the scaling circuits 104_1-104_N with the processed data portions D_21′-D_2N′ generated from the scaling circuits 604_1-604_N, and then outputting the display data portions DO_V-DO_N′ through the channels CH_1-CH_N respectively. In other words, the data portion DO_1′ is a mixing result of the processed data portions D_11′ and D_21′, the data portion DO_N′ is a mixing result of the processed data portions D_1N′ and D_2N′, and the rest can be deduced by analogy.

By way of example, but not limitation, one of the input images IMG_1 and IMG_2 may be a still picture or a frame of a video stream, and the other of the input images IMG_1 and IMG_2 may be an on-screen display (OSD) image. Therefore, a scaled image displayed at a receiving end (e.g., a display panel) will have a scaled OSD image overlaid on a scaled still picture or a scaled frame of the video stream. Alternatively, one of the input images IMG_1 and IMG_2 may be a main picture for picture-in-picture (PIP) display, and the other of the input images IMG_1 and IMG_2 may be a sub-picture for PIP display. Therefore, a scaled image displayed at a receiving end (e.g., a display panel) will have a scaled sub-picture overlaid on a scaled main picture.

FIG. 2 shows that two data portions are derived from two partial image areas determined within the input image IMG_1. However, this is not meant to be a limitation of the present invention. In practice, the number of channels coupled between the image processing apparatus 100/600 and the display panel (not shown) depends on the actual resolution of the display panel, the actual frame rate of the display panel, and the highest pixel clock rate supported by the image processing apparatus. That is, the number of data portions generated from the original data of the input image is based on the actual design consideration/requirement.

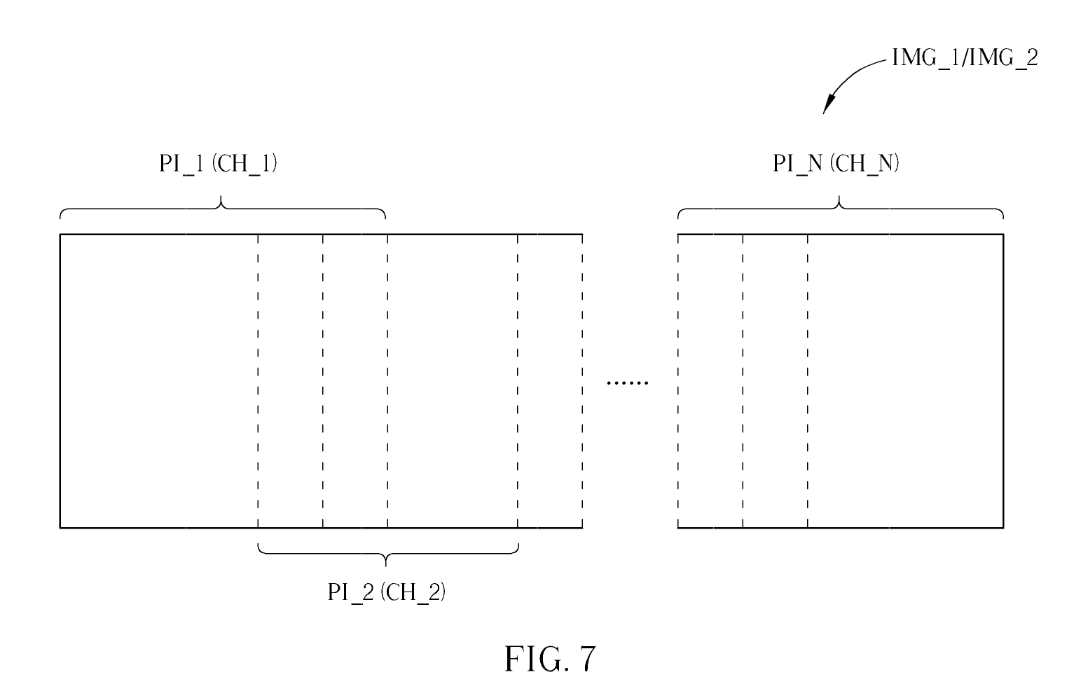

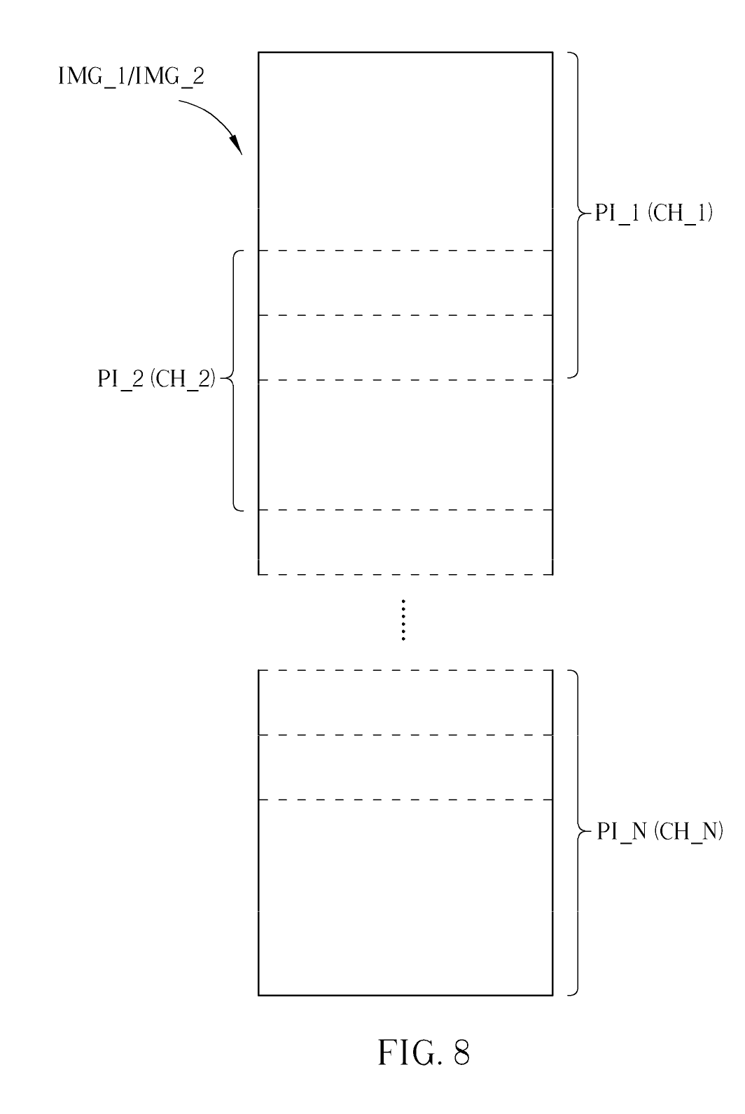

It should be noted that the number of channels is equal to the number of data portions generated from the original data of the input image (i.e., the number of partial image areas to which the data portions correspond). Please refer to FIG. 7, which is a diagram illustrating a generalized arrangement of the partial image areas according to an embodiment of the present invention. As shown in the figure, the partial image areas PI_1-PI_N respectively corresponding to channels CH_1-CH_N are arranged in a horizontal direction of the input image IMG_1/IMG_2. Please refer to FIG. 8, which is a diagram illustrating another generalized arrangement of the partial image areas according to an embodiment of the present invention. Therefore, each scaling operation with multi-tap filtering is employed for processing pixels disposed at the same row. As shown in the figure, the partial image areas PI_1-PI_N respectively corresponding to channels CH_1-CH_N are arranged in a vertical direction of the input image IMG_1/IMG_2. Therefore, each scaling operation with multi-tap filtering is employed for processing pixels disposed at the same column.

In above exemplary embodiments, two adjacent partial image areas are overlapped with each other. Therefore, when the scaling operation with multi-tap filtering is employed, a seamless output can be obtained at the display panel. However, if the scaling circuit is designed to employ a scaling operation different from the aforementioned scaling operation with multi-tap filtering and/or a non-seamless output is acceptable under certain applications, the adjacent partial image areas may be non-overlapped partial image areas. For example, one partial image area may include the areas A1 and A2 shown in FIG. 2, and the other partial image area may include the areas A3 and A4 shown in FIG. 2. To put it simply, the spirit of the present invention is obeyed as long as a multi-channel transmission is employed for transmitting data generated from performing scaling operations upon data portions corresponding overlapped/non-overlapped partial image areas with an input image.

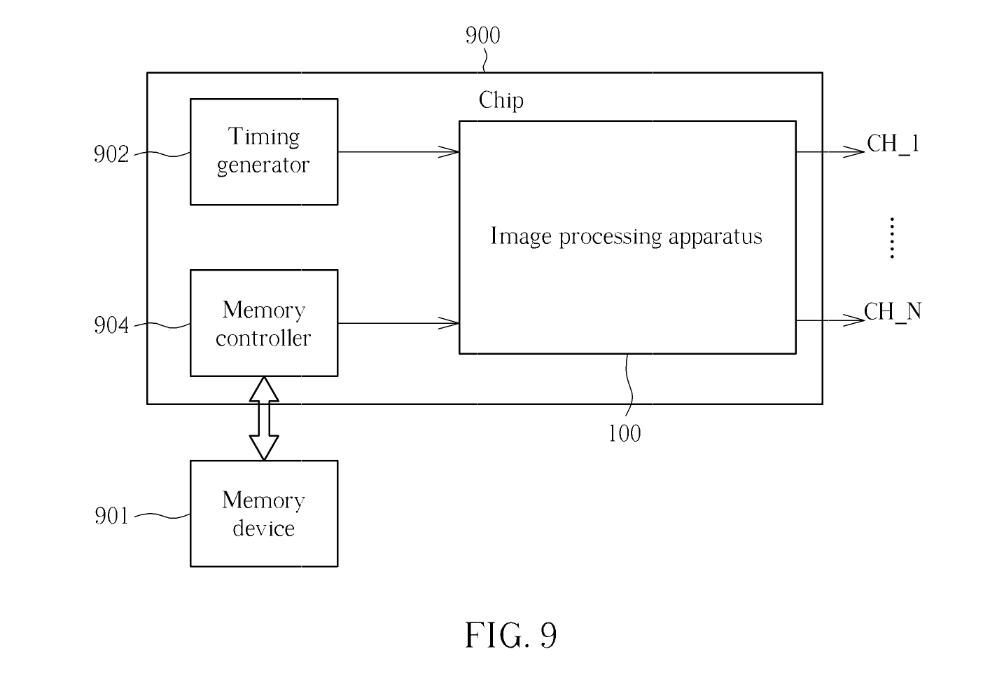

In one exemplary embodiment, the image processing apparatus 100 may be realized by a single-chip implementation. Please refer to FIG. 9 in conjunction with FIG. 1. FIG. 9 is a block diagram illustrating an exemplary single-chip implementation according to the present invention. The exemplary chip 900 includes, but is not limited to, the aforementioned image processing apparatus 100, a timing generator 902, and a memory controller 904. Therefore, the splitting module 102, the scaling circuits 104_1-104_N, and the output circuits 106_1-106_N are all disposed on the same chip 900. The memory controller 904 is arranged to access a memory device 901 external to the chip 900, and then transmit the image data (e.g., the original data DI_1 of the input image IMG_1) to the splitting module 102 of the image processing apparatus 100. The timing generator 902 controls the operational timing of the internal circuit elements of the image processing apparatus 100. For example, the operations of the scaling circuits 104_1-104_N are synchronized with one another under the control of the timing generator 902. Besides, the operations of the output circuits 106_1-106_N are also synchronized with one another under the control of the timing generator 902.

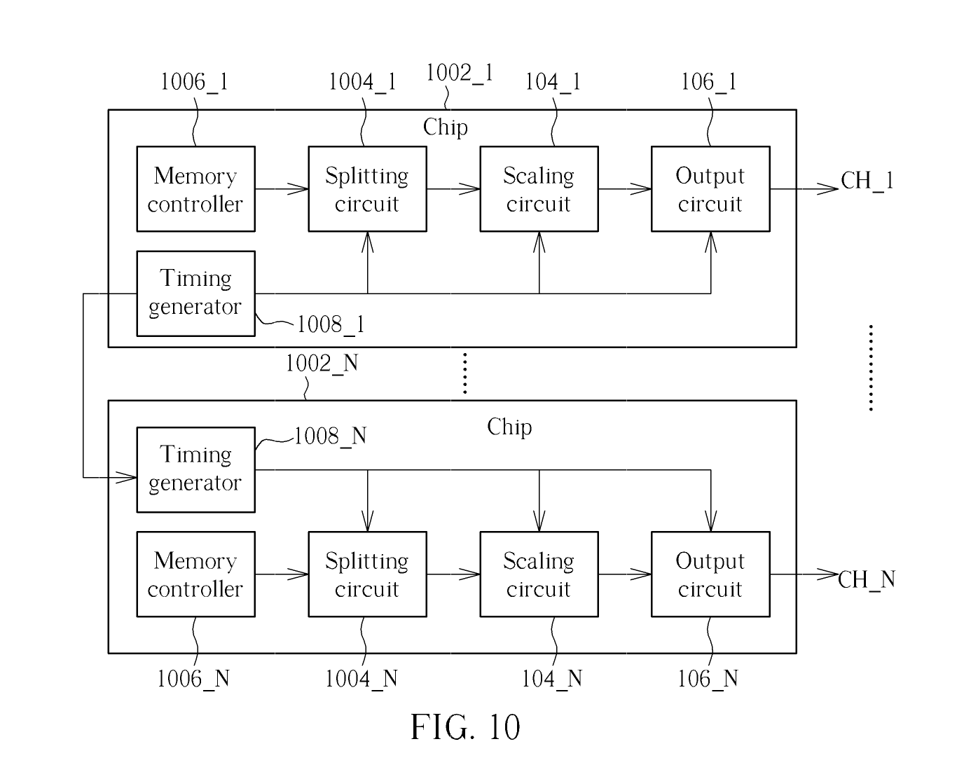

In another exemplary embodiment, the image processing apparatus 100 may be realized by a multi-chip implementation. Please refer to FIG. 10 in conjunction with FIG. 1. FIG. 10 is a block diagram illustrating an exemplary multi-chip implementation according to the present invention. The multi-chip implementation includes a plurality of chips 1002_1-1002_N. In this exemplary embodiment, the splitting module 102 includes a plurality of splitting circuits 1004_1-1004_N disposed in the chips 1002_1-1002_N respectively. Besides, the scaling circuits 104_1-104_N are disposed in the chips 1002_1-1002_N respectively, and the output circuits 106_1-106_N are disposed in the chips 1002_1-1002_N respectively. Please note that a combination of the splitting circuits 1004_1-1004_N, the scaling circuits 104_1-104_N, and the output circuits 106_1-106_N is the image processing apparatus 100 shown in FIG. 1.

Moreover, as shown in FIG. 10, there are memory controllers 1006_1-1006_N disposed in the chips 1002_1-1002_N respectively, and timing generators 1008_1-1008_N disposed in the chips 1002_1-1002_N respectively. The memory controllers 1006_1-1006_N are arranged to access an external memory device (e.g., the memory device 901 shown in FIG. 9), and then transmit the image data (e.g., the original data DI_1 of the input image IMG_1) to the splitting circuits 1004_1-1004_N. The timing generators 1008_1-1008_N are synchronized with one another, and are arranged to control the operational timing of the image processing apparatus's internal circuit elements such as the splitting circuits 1004_1-1004_N, the scaling circuits 104_1-104_N, and the output circuits 106_1-106_N.

It should be noted that the image processing apparatus 600 shown in FIG. 6 may also be realized by a single-chip implementation or a multi-chip implementation. As a person skilled in the art can readily understand details of the single-chip implementation/multi-chip implementation of the image processing apparatus 600 after reading above paragraphs, further description is omitted here for brevity.

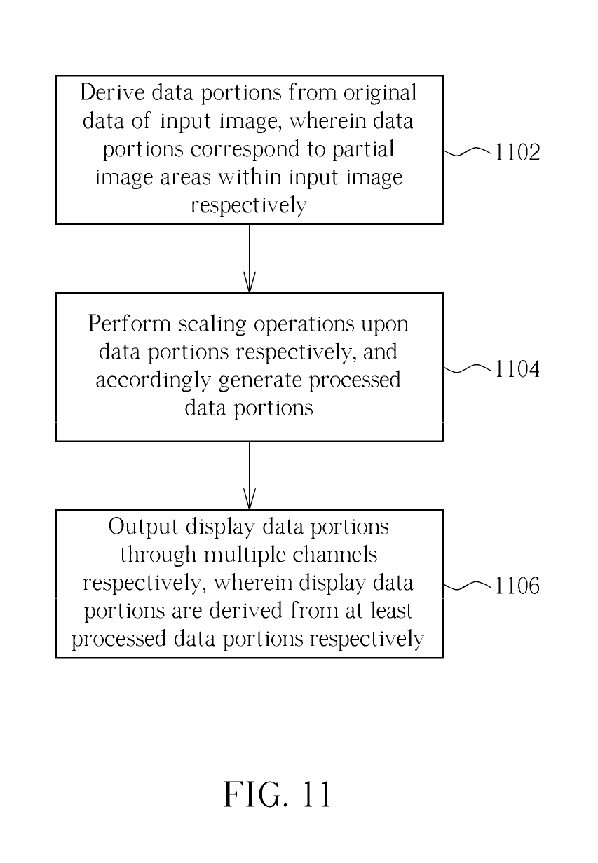

FIG. 11 is a flowchart illustrating an image processing method according to an exemplary embodiment of the present invention. If the result is substantially the same, the steps are not required to be executed in the exact order shown in FIG. 11. The image processing method may be employed by the image processing apparatus 100/600, and may be briefly summarized as follows.

Step 1102: Derive a plurality of data portions from an original data of an input image, wherein the data portions correspond to a plurality of partial image areas within the input image respectively.

Step 1104: Perform a plurality of scaling operations upon the data portions respectively, and accordingly generate a plurality of processed data portions.

Step 1106: Output a plurality of display data portions through a plurality of channels respectively, wherein the display data portions are derived from at least the processed data portions respectively.

As a person skilled in the art can readily understand details of each step after reading above paragraphs directed to the exemplary image processing apparatus 100/600, further description is omitted here for brevity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing method, comprising:
deriving a plurality of first data portions from an original data of a first input image, wherein the first data portions correspond to a plurality of partial image areas within the first input image respectively;
performing a plurality of scaling operations upon the first data portions respectively, and accordingly generating a plurality of first processed data portions; and
outputting a plurality of display data portions through a plurality of channels respectively, wherein the display data portions are derived from at least the first processed data portions respectively.

2. The image processing method of claim 1, wherein every two adjacent partial image areas of the partial image areas within the first input image are overlapped with each other.

3. The image processing method of claim 2, wherein each of the scaling operations is a scaling operation with multi-tap filtering.

4. The image processing method of claim 3, wherein the step of performing the scaling operations upon the first data portions comprises:
setting a plurality of predetermined initial phases corresponding to the channels respectively; and
performing the scaling operations upon the first data portions according to the predetermined initial phases respectively.

5. The image processing method of claim 1, wherein the partial image areas are arranged in a horizontal direction of the first input image.

6. The image processing method of claim 1, wherein the partial image areas are arranged in a vertical direction of the first input image.

7. The image processing method of claim 1, further comprising:
deriving a plurality of second data portions from an original data of a second input image, wherein the second data portions correspond to a plurality of partial image areas within the second input image respectively;
performing a plurality of scaling operations upon the second data portions respectively, and accordingly generating a plurality of second processed data portions;
wherein the step of outputting the display data portions comprises:
generating the display data portions by mixing the first processed data portions with the second processed data portions respectively; and
transmitting the display data portions to the channels respectively.

8. The image processing method of claim 7, wherein one of the first input image and the second input image is an on-screen display (OSD) image; or one of the first input image and the second input image is a main picture for picture-in-picture (PIP) display, and the other of the first input image and the second input image is a sub-picture for PIP display.

9. The image processing method of claim 1, wherein the first input image is a still picture, a frame of a video stream, or an on-screen display (OSD) image.

10. An image processing apparatus, comprising:
a first splitting module, arranged for deriving a plurality of first data portions from an original data of a first input image, wherein the first data portions correspond to a plurality of partial image areas within the first input image respectively;
a plurality of first scaling circuits, coupled to the first splitting module, the first scaling circuits arranged for performing a plurality of scaling operations upon the first data portions respectively, and accordingly generating a plurality of first processed data portions; and
a plurality of output circuits, coupled to the first scaling circuits respectively, the output circuits arranged for outputting a plurality of display data portions through a plurality of channels respectively, wherein the display data portions are derived from at least the first processed data portions respectively.

11. The image processing apparatus of claim 10, wherein every two adjacent partial image areas of the partial image areas within the first input image are overlapped with each other.

12. The image processing apparatus of claim 11, wherein each of the scaling operations performed by the first scaling circuits is a scaling operation with multi-tap filtering.

13. The image processing apparatus of claim 12, wherein the first scaling circuits set a plurality of predetermined initial phases corresponding to the channels respectively, and perform the scaling operations upon the first data portions according to the predetermined initial phases respectively.

14. The image processing apparatus of claim 10, wherein the partial image areas are arranged in a horizontal direction of the first input image.

15. The image processing apparatus of claim 10, wherein the partial image areas are arranged in a vertical direction of the first input image.

16. The image processing apparatus of claim 10, further comprising:
a second splitting module, arranged for deriving a plurality of second data portions from an original data of a second input image, wherein the second data portions correspond to a plurality of partial image areas within the second input image respectively;
a plurality of second scaling circuits, coupled to the second splitting module, the second scaling circuits arranged for performing a plurality of scaling operations upon the second data portions respectively, and accordingly generating a plurality of second processed data portions;
wherein the output circuits are further coupled to the second scaling circuits respectively, and arranged for generating the display data portions by mixing the first processed data portions with the second processed data portions respectively, and outputting the display data portions through the channels respectively.

17. The image processing apparatus of claim 16, wherein one of the first input image and the second input image is an on-screen display (OSD) image; or one of the first input image and the second input image is a main picture for picture-in-picture (PIP) display, and the other of the first input image and the second input image is a sub-picture for PIP display.

18. The image processing apparatus of claim 10, wherein the first input image is a still picture, a frame of a video stream, or an on-screen display (OSD) image.

19. The image processing apparatus of claim 10, wherein the first splitting module, the first scaling circuits, and the output circuits are integrated in a single chip.

20. The image processing apparatus of claim 10, wherein the first splitting module includes a plurality of splitting circuits arranged for generating the first data portions respectively; the splitting circuits are disposed in a plurality of chips respectively, the first scaling circuits are disposed in the chips respectively, and the output circuits are disposed in the chips respectively.
